(19) United States
(12) Patent Application Publication
(10) Pub. No.: US 2011/0229247 A1
(43) Pub. Date: Sep. 22, 2011

(54) ADAPTER HAVING DOUBLE ROLLER FOR FLUID-MATERIAL SPREAD AND FLUID-MATERIAL SPREAD APPARATUS HAVING THE SAME

(75) Inventor: Ho Suk SONG, Incheon (KR)

(73) Assignee: S & P World Ltd., Incheon (KR)

(21) Appl. No.: 13/018,519

(22) Filed: Feb. 1, 2011

(30) Foreign Application Priority Data
Mar. 16, 2010 (KR) 10-2010-0023373

(51) Int. Cl. B05C 17/025

(52) U.S. Cl. 401/147

(57) ABSTRACT

Disclosed herein is a liquid-material application adapter with a dual roller structure. The adapter includes a roller support having on an upper portion thereof a discharge port for discharging liquid material, a first roller unit rotatably placed above a lower surface of the roller support and making contact with the liquid material discharged through the discharge port, and a second roller unit placed on a side of the first roller unit to be in contact with the first roller unit and rotatably coupled to the roller support. The adapter is constructed to apply liquid material using the second roller unit, thus preventing the liquid material from adhering to an undesired place when the liquid material is applied, and is constructed so that liquid material of the second roller unit is evenly spread out by the first roller unit, thus enabling the liquid material to be evenly applied.

### BACKGROUND OF THE INVENTION

1. Field of the Invention

The present invention relates generally to an adapter which is intended to apply liquid material. More particularly, the present invention relates to a liquid-material application adapter which is capable of evenly applying liquid material using a dual roller structure, and a liquid-material application apparatus having the adapter.

2. Description of the Related Art

Conventional liquid material is applied to a desired place using the hand or a brush, after being discharged from a container containing the liquid material. During the operation of applying the liquid material, the liquid material may adhere to an undesired place, for example, the hand or clothing.

In order to solve the problem, it was attempted to apply liquid material using one roller. However, in the case of applying the liquid material using only one roller, an excessively large or small amount of liquid material is applied to the roller, so that it is impossible to evenly apply the contents. Particularly when an excessively large amount of liquid material is applied to the roller, the roller swells up, so that it is not easy to rotate the roller.

### SUMMARY OF THE INVENTION

Accordingly, the present invention has been made keeping in mind the above problems occurring in the prior art, and an object of the present invention is to provide a liquid-material application adapter with a dual roller structure, which prevents liquid material from being applied to undesired places.

Another object of the present invention is to provide a liquid-material application adapter with a dual roller structure, which enables liquid material to be evenly applied to a desired place.

A further object of the present invention is to provide a liquid-material application adapter with a dual roller structure, which allows a roller to rotate smoothly even if the adapter is used repeatedly.

Further, another object of the present invention is to provide a liquid-material application apparatus having a liquid-material application adapter, which enables a predetermined amount of liquid material to be discharged and thus be evenly applied.

The objects of the present invention are not limited to the above-mentioned objects, and other objects which are not mentioned could be clearly understood by those skilled in the art from the following description.

In order to accomplish the above objects, the present invention provides a liquid-material application adapter with a dual roller structure, including a roller support having on an upper portion thereof a discharge port for discharging liquid material; a first roller unit rotatably placed above a lower surface of the roller support, and making contact with the liquid material discharged through the discharge port; and a second roller unit placed on a side of the first roller unit to be in contact with the first roller unit, and rotatably coupled to the roller support.

The first roller unit rotates while being in contact with the second roller unit during rotation of the second roller unit, thus transferring the liquid material from the discharge port to the second roller unit.

A concave part may be provided in the upper portion of the roller support to receive the first roller unit.

The discharge port may be formed on the concave part to communicate therewith.

A depressed portion may be provided in the concave part to receive the liquid material discharged from the discharge port.

The discharge port may be formed to communicate with the depressed portion.

A plurality of grooves may be formed on the first roller unit.

The grooves may be continuously formed in a direction perpendicular to a direction of rotation of the first roller unit or in the same direction as the direction of rotation thereof.

The grooves may be discontinuously formed in a direction perpendicular to a direction of rotation of the first roller unit or in the same direction as the direction of rotation thereof.

The grooves may be continuously or discontinuously formed in a direction inclined relative to a direction of rotation of the first roller unit.

The grooves may cross each other.

A plurality of protrusions may be formed on the first roller unit.

The first roller unit may comprise a plurality of balls.

At least one of the first and second roller units may comprise a plurality of rollers.

When the first roller unit comprises two rollers and the second roller unit comprises one roller, first and second rollers of the first roller unit may be in contact with the roller of the second roller unit, and the first and second rollers of the first roller unit may be spaced apart from each other.

When the first roller unit comprises one roller and the second roller unit comprises two rollers, the roller of the first roller unit may be placed between first and second rollers of the second roller unit in such a way as to be in contact therewith, and the first and second rollers of the second roller unit may be spaced apart from each other.

When the first roller unit comprises two rollers and the second roller unit comprises one roller, first and second rollers of the first roller unit may be in contact with the roller of the second roller unit, and the first and second rollers of the first roller unit may be spaced apart from each other.

When the first roller unit comprises two rollers and the second roller unit comprises two rollers, a first roller of the first roller unit may be in contact with a first roller of the second roller unit, and a second roller of the first roller unit may be in contact with a second roller of the second roller unit, the first and second rollers of the first roller unit being spaced apart from each other, and the first and second rollers of the second roller unit being spaced apart from each other.

When the first roller unit comprises three rollers and the second roller unit comprises one roller, a first roller of the first roller unit may have on opposite sides thereof second and third rollers which are spaced apart from the roller of the second roller unit and are in contact with the first roller.

When the first roller unit comprises three rollers and the second roller unit comprises one roller, a first roller of the first roller unit may have on opposite sides thereof second and third rollers which are in contact with the first roller, and the roller of the second roller unit may be in contact with the second and third rollers of the first roller unit, and the first roller of the first roller unit and the roller of the second roller unit may be spaced apart from each other.

When the first roller unit comprises three rollers and the second roller unit comprises two rollers, a first roller of the first roller unit may have on opposite sides thereof second and third rollers which are spaced apart from each other, and first and second rollers of the second roller unit may be placed, respectively, between the first and second rollers of the first roller unit and between the first and third rollers of the first roller unit, and the first and second rollers of the second roller unit may be spaced apart from each other and rotate the first roller unit when the second roller unit rotates.

In order to accomplish the above objects, the present invention provides a liquid-material application adapter with a dual roller structure, including a first roller support having on an upper portion thereof a discharge port for discharging liquid material; a first roller unit rotatably placed on the upper portion of the first roller support, and making contact with the liquid material discharged from the discharge port; a second roller support placed on the first roller support, and having a slit through which a surface of the first roller unit is exposed; and a second roller unit rotatably coupled to the second roller support to be in contact with the first roller unit which is exposed through the slit.

When the second roller unit rotates, the first roller unit rotates while being in contact with the second roller unit, thus transferring the liquid material from the discharge port to the second roller unit.

Further, in order to accomplish the above objects, the present invention provides a liquid-material application apparatus, including a liquid-material application adapter; and a container having an outlet that communicates with a discharge port of the liquid-material application adapter, and coupled with the liquid-material application adapter, with a pump being provided in the outlet of the container.

The pump may include on a side thereof a pressurizing part, the pressurizing part being in contact with the liquid-material application adapter to be pressurized when the liquid-material application adapter moves up and down.

An inclined part may be provided at a predetermined position on an outer surface of the liquid-material application adapter to pressurize the liquid-material application adapter.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a liquid-material application adapter with a dual roller structure according to an embodiment of the present invention;

FIG. 2 is an exploded perspective view showing the liquid-material application adapter with the dual roller structure shown in FIG. 1;

FIGS. 3A to 3E are perspective views showing embodiments of a first roller unit of a liquid-material application apparatus according to the present invention;

FIGS. 4A to 4G are conceptual views showing various embodiments of first and second roller units according to the present invention;

FIG. 5 is a partially exploded perspective view showing an adapter with a dual roller structure according to another embodiment of the present invention;

FIG. 6A is a perspective view showing a liquid-material application apparatus having a liquid-material application adapter according to an embodiment of the present invention;

FIG. 6B is a sectional view showing the liquid-material application apparatus having the liquid-material application adapter shown in FIG. 6A;

FIG. 7A is a perspective view showing a liquid-material application apparatus having a liquid-material application adapter according to another embodiment of the present invention; and

FIG. 7B is a sectional view showing the liquid-material application apparatus having the liquid-material application adapter shown in FIG. 7A.

### DESCRIPTION OF THE PREFERRED EMBODIMENTS

Hereinafter, a liquid-material application apparatus having a dual roller structure according to the present invention will be described with reference to the accompanying drawings.

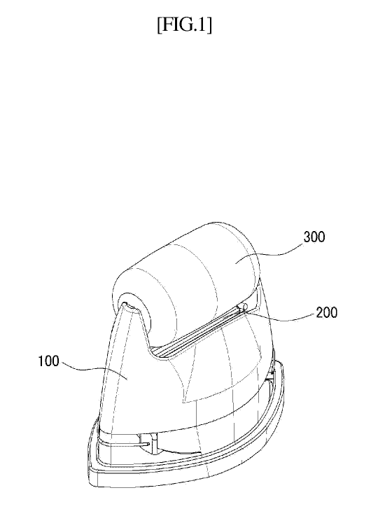

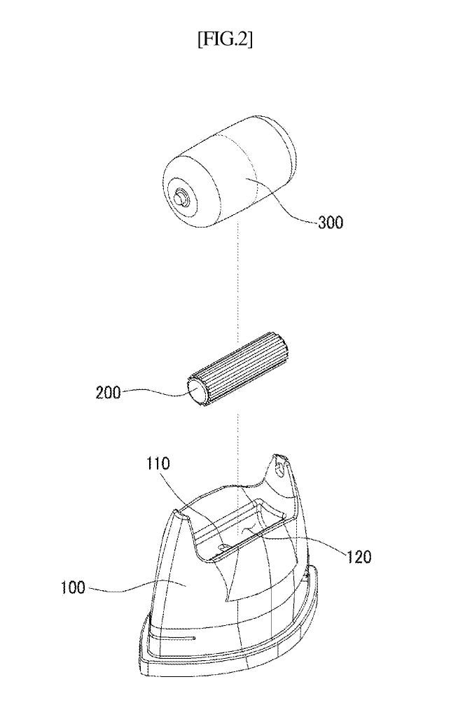

FIG. 1 is a perspective view showing a liquid-material application adapter (hereinafter, referred to as an ‘adapter’) with a dual roller structure according to an embodiment of the present invention, and FIG. 2 is an exploded perspective view of the adapter.

As shown in FIG. 1, the liquid-material application apparatus according to the present invention includes a roller support 100, a first roller unit 200, and a second roller unit 300. When the second roller unit 300 rotates, the first roller unit 200 also rotates while being in contact with the second roller unit 300.

The roller support 100 receives the first and second roller units 200 and 300. As shown in FIG. 2, a discharge port 110 is formed in a lower surface of the roller support 100 to discharge contents therefrom.

The roller units accommodated in the roller support 100 are disposed above the lower surface of the roller support 100, and comprise the first roller unit 200 which is in contact with the contents discharged from the discharge port 110, and the second roller unit 300 which is placed on a side of the first roller unit 200 to be in contact with the first roller unit 200.

Thus, when the second roller unit 300 rotates while making contact with a surface to which contents are to be applied, the first roller unit 200 rotates while being in contact with the second roller unit 300. When the first and second roller units 200 and 300 rotate, the contents discharged from the discharge port 110 are applied to the first roller unit 200, and then are transferred from the first roller unit 200 to the second roller unit 300.

The first and second roller units 200 and 300 may be made of soft or hard material. However, it is preferable that the second roller unit 300 be made of soft material.

As shown in FIG. 2, a concave part 120 is formed in an upper portion of the roller support 100 according to the present invention to receive the first roller unit 200 therein.

The concave part 120 is formed by depressing the lower surface of the roller support 100 down in a concave manner, and has a shape corresponding to that of the first roller unit 200 so that the first roller unit 200 can be received therein.

As shown in FIG. 2, the discharge port 110 is formed on the concave part 120 to communicate therewith. Preferably, a depressed portion (not shown) is formed on a surface of the concave part 120 on which the discharge port 110 is formed to communicate therewith, thus allowing the contents discharged from the discharge port 110 to temporarily stay in the depressed portion before the contents make contact with the first roller unit 200.

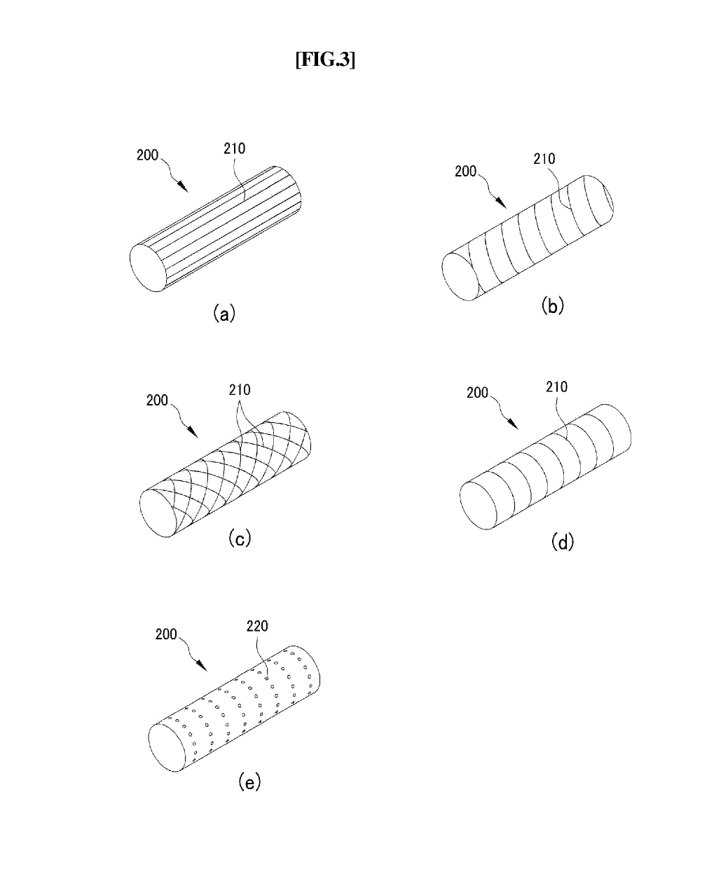

FIGS. 3A to 3E are views showing embodiments of the first roller unit 200 of the liquid-material application apparatus according to the present invention. The first roller unit 200 will be described below with reference to FIGS. 3A to 3E.

The first roller unit 200 according to the present invention may be formed in various shapes. According to this embodiment, the first roller unit 200 has a cylindrical shape as shown in FIGS. 3A to 3E.

Such a first roller unit 200 may be provided with a plurality of grooves 210. The grooves 210 formed on the first roller unit 200 may be oriented in a direction perpendicular to the direction of rotation of the first roller unit 200 as shown in FIG. 3A, or may be oriented in the same direction as the direction of rotation as shown in FIG. 3D. The grooves 210 may be continuously formed as shown in FIGS. 3A to 3D, or may be discontinuously formed according to an embodiment.

Further, the grooves 210 of the first roller unit 200 according to the present invention may be continuously formed in a direction which is inclined relative to the direction of rotation of the first roller unit 110, as shown in FIG. 3B, or may be discontinuously formed according to an embodiment.

When the grooves 210 of the first roller unit 200 are formed in a direction which is inclined relative to the direction of rotation of the first roller unit 110, the grooves 210 of the first roller unit 200 may cross each other as shown in FIG. 3C.

Further, a plurality of protrusions 220 may be formed on the outer surface of the first roller unit 200 according to the present invention, as shown in FIG. 3E.

The grooves 210 formed on the outer surface of the first roller unit 200 may be formed at various depths and intervals according to embodiments. Further, the protrusions 220 of FIG. 3E may also be formed in various shapes.

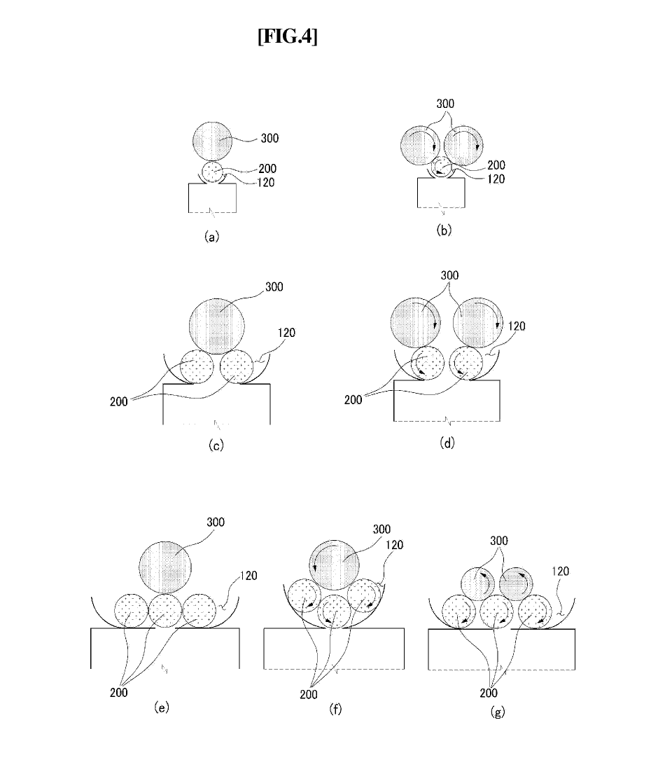

FIGS. 4A to 4G are views showing various embodiments of the first and second roller units 200 and 300 according to the present invention. The first and second roller units 200 and 300 will be described in detail with reference to FIGS. 4A to 4G.

Further, the first roller unit 200 may comprise a plurality of balls, in addition to the cylindrical shape.

FIGS. 4A to 4G are views showing various embodiments of the first and second roller units 200 and 300 according to the present invention. The first and second roller units 200 and 300 will be described in detail with reference to FIGS. 4A to 4G.

As shown in FIGS. 4B to 4G, it is preferable that at least one of the first and second roller units 200 and 300 include a plurality of rollers.

As shown in FIG. 4B, when the first roller unit 200 includes one roller and the second roller unit 300 includes two rollers, the roller of the first roller unit 200 is preferably arranged between the rollers of the second roller unit 300 in such a way as to be put in contact with the rollers. More preferably, the rollers of the second roller unit 300 are spaced apart from each other.

When the first and second roller units 200 and 300 are arranged as shown in FIG. 4B, the two rollers of the second roller unit 300 rotate in the same direction, and the roller of the first roller unit 200 which is in contact with the rollers of the second roller unit 300 rotates in a direction opposite to the rollers of the second roller unit 300 when the rollers of the second roller unit 30 rotate, thus transferring contents from the discharge port 110 to the rollers of the second roller unit 300. Thus, the contents transmitted to the second roller unit 300 may be applied over a larger area.

Further, as shown in FIG. 4C, when the first roller unit 200 includes two rollers and the second roller unit 300 includes one roller, the two rollers of the first roller unit 200 are preferably arranged so that they are in contact with the roller of the second roller unit 300. It is more preferable that the rollers of the first roller unit 200 be spaced apart from each other.

In this case, one pair of rollers of the first roller unit 200 rotate in the same direction by the roller of the second roller unit 300, thus transmitting contents from the discharge port 110 to the roller of the second roller unit 300.

Here, since the first roller unit 200 includes two rollers, the contents discharged from the discharge port 110 may be transmitted over a larger area of the roller of the second roller unit 300.

Further, as shown in FIG. 4D, when the first roller unit 200 includes two rollers and the second roller unit 300 includes two rollers, the first and second roller units 200 and 300 may be arranged such that a first roller of the first roller unit 200 makes contact with a first roller of the second roller unit 300, and a second roller of the first roller unit 200 makes contact with a second roller of the second roller unit 300.

More preferably, the first and second rollers of the first roller unit 200 are spaced apart from each other, and the first and second rollers of the second roller unit 300 are spaced apart from each other.

In this case, contents discharged from the discharge port 110 are applied to the first and second rollers of the first roller unit 200, respectively, so that the contents may be independently transmitted to the first and second rollers of the second roller unit 300. Thus, even if a surface which is in contact with the second roller unit 300 is not flat, the contents may be evenly applied onto the surface.

Further, as shown in FIG. 4E, when the first roller unit 200 includes three rollers and the second roller unit 300 includes one roller, a first roller of the first roller unit 200 makes contact with the roller of the second roller unit 300, and second and third rollers of the first roller unit 200 are provided on opposite sides of the first roller in such a way as to be spaced apart from the roller of the second roller unit 300 and be in contact with the first roller.

In this case, after contents discharged from the discharge port 110 are applied to the first roller which is placed above the discharge port 110, the contents are evenly spread out by the second and third rollers of the first roller unit 200. Thereafter, the contents are transmitted to the roller of the second roller unit 300.

Further, as shown in FIG. 4F, when the first roller unit 200 includes three rollers and the second roller unit 300 includes one roller, then second and third rollers of the first roller unit 200 are arranged on opposite sides of a first roller of the first roller unit 200 in such a way as to be in contact with the first roller thereof, and the roller of the second roller unit 300 are arranged to be in contact with the second and third rollers of the first roller unit 200.

Preferably, the first roller of the first roller unit 200 is spaced apart from the roller of the second roller unit 300.

In this case, after contents discharged from the discharge port 110 is primarily applied to the first roller of the first roller unit 200 which is placed above the discharge port 110, the contents are evenly transmitted to the second and third rollers which are arranged on opposite sides of the first roller, and thereafter are transmitted to the roller of the second roller unit 300. Thus, the contents may be more evenly spread onto the roller of the second roller unit 300.

Further, as shown in FIG. 4G, when the first roller unit 200 includes three rollers and the second roller unit 300 includes two rollers, then second and third rollers of the first roller unit 200 are arranged on opposite sides of a first roller of the first roller unit 200 in such a way as to be spaced apart from each other.

In this case, first and second rollers of the second roller unit 300 are arranged, respectively, between the first and second rollers of the first roller unit 200 and between the first and third rollers of the first roller unit 200, thus rotating the rollers of the first roller unit 200.

Thus, contents transmitted to the respective rollers of the second roller unit 300 are evenly spread by two rollers of the first roller unit 200.

Preferably, the first and second rollers of the second roller unit 300 are spaced apart from each other.

When the second roller unit according to the present invention includes a plurality of rollers, it is preferable that the respective rollers have the same direction of rotation.

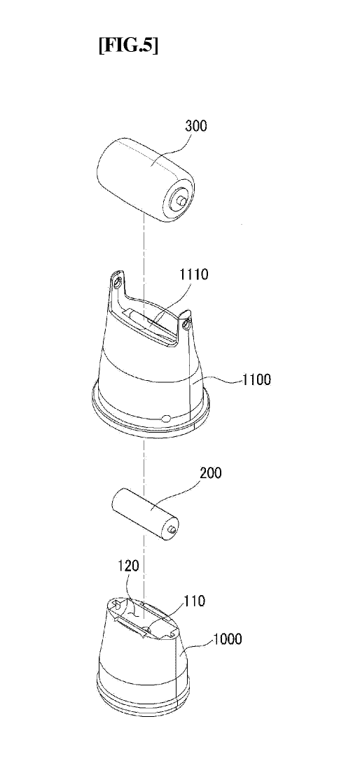

FIG. 5 is a partially exploded perspective view showing an adapter according to another embodiment of the present invention. The adapter will be described below with reference to FIG. 5.

The adapter according to the present invention includes a first roller support 1000, a first roller unit 200, a second roller support 1100, and a second roller unit 300.

Among the components of the adapter, the first and second roller units 200 and 300 have been described above. In order to avoid duplicating the description, the description of the first and second roller units 200 and 300 will be omitted. The first and second roller supports 1000 and 1100 will be described below in detail.

The first roller support 1000 has on its upper surface a discharge port 110 to discharge contents therethrough. A concave part 120 is formed in an upper portion of the first roller support 1000 such that the first roller unit 100 may be placed therein. The discharge port 110 is formed on the concave part 120 to communicate therewith.

The second roller unit 300 is rotatably coupled to the second roller support 1100. A slit 1110 is formed through the upper surface of the second roller support 1100 such that a surface of the first roller unit 200 protrudes through the slit 1110 when the second roller support 1100 is coupled with the first roller support 1000.

The second roller unit 300 is coupled to the second roller support 1100 in such a way as to be put in contact with the first roller unit 100 protruding through the slit 1110.

Thus, when the second roller unit 300 rotates, the first roller unit 200 rotates while being in contact with the second roller unit 300, so that contents are transferred from the discharge port 110 to the second roller unit 300.

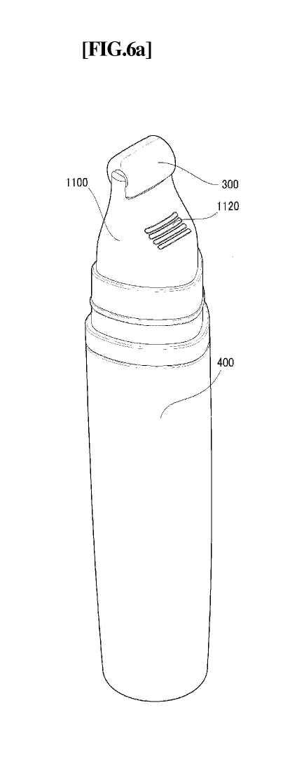

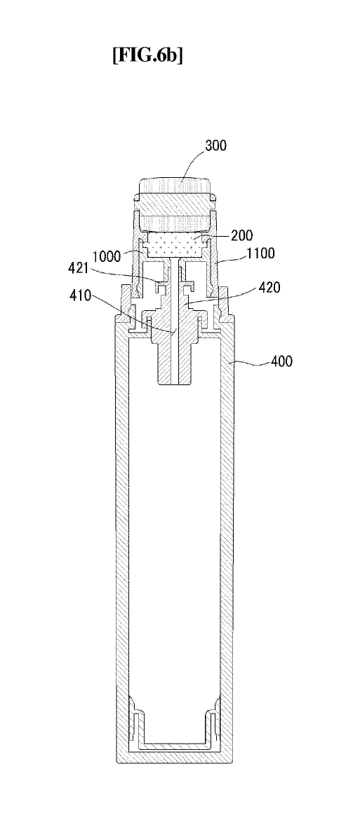

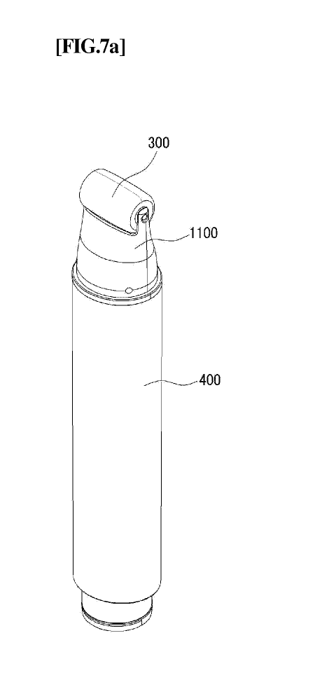

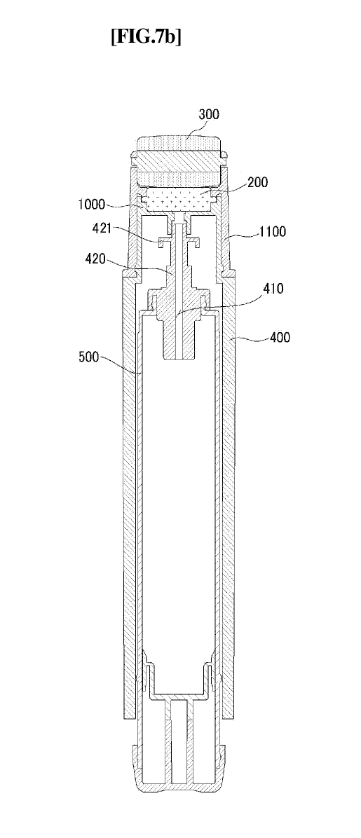

Each adapter shown in FIGS. 1, 2, and 5 may be coupled to various types of containers 400 as shown in FIGS. 6A and 7A. Each container 400 is provided with an outlet 410 which communicates with the discharge port 110. Here, a pump 420 may be provided in the container 400.

Since the roller support 1000, the first roller unit 200, and the second roller unit 300 have been described above, only the container 400 will be described below so as to avoid duplicating the description.

FIGS. 6A to 7B are views illustrating liquid-material application apparatuses having the liquid-material application adapter according to the present invention in sectional views and perspective views.

As shown in FIGS. 6A to 7B, the container 400 holds liquid material therein, and includes the outlet 410 which communicates with the discharge port 110 of the liquid-material application adapter.

The pump 420 is provided in the outlet 410 of the container 400, as shown in FIGS. 6B and 7B.

The pump 420 generates a difference in pressure between the inside and outside of the container 400, thus discharging liquid material out of the container 400.

As shown in FIGS. 6B and 7B, a pressurizing part 421 may be provided on a side of the pump 420. The pressurizing part 421 is provided to be in contact with a lower portion of the liquid-material application adapter, namely, the first roller support 1000, as shown in FIG. 6B.

Thus, when the liquid-material application adapter moves up and down, the pressurizing part 421 is pressurized by the first roller support 1000 of the liquid-material application adapter, thus discharging liquid material out of the container 400.

Here, as shown in FIG. 6A, an inclined part 1120 is preferably provided on an outer surface of the liquid-material application adapter to pressurize the liquid-material application adapter.

As for the embodiment shown in FIG. 6B, the pressurizing part 421 may be constructed to come into contact with the first roller support 1000. As for the embodiment shown in FIG. 1, the pressurizing part 421 may be constructed to come into contact with the roller support 1000.

Such a container 400 may hold various liquid materials, for example, liquid cosmetics, such as foundation, BB cream, or suncream, medicines such as a medical ointment, or adhesives.

Further, as shown in FIGS. 7A and 7B, a separate holding part 500 may be provided in the container 400 in such a way as to be coupled to the pump 420, and the first roller support 1000 may be coupled to the container 400. As shown in FIGS. 7A and 7B, the pump 420 is operated when a lower portion of the holding part 500 is pressurized.

As described above, the present invention provides a liquid-material application adapter with a dual roller structure, which is constructed to apply liquid material using a second roller unit, thus preventing the liquid material from adhering to an undesired place, such as a user's clothing or hands, when the liquid material is applied, and is constructed so that liquid material of the second roller unit is evenly spread out by a first roller unit, thus enabling the liquid material to be evenly applied. Further, the adapter has the dual roller structure, thus preventing the roller from swelling up when the adapter is repeatedly used.

Further, the present invention provides a liquid-material application apparatus having a liquid-material application adapter, which allows contents to be uniformly discharged out of a container using a pump and to be evenly applied.

The effects of the present invention are not limited to the above-mentioned effects, and other effects which are not mentioned could be clearly understood by those skilled in the art from the description.

It is to be understood that the form of the invention herein shown and described is for illustrative purposes only. Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A liquid-material application adapter with a dual roller structure, comprising:
a roller support having on an upper portion thereof a discharge port for discharging liquid material;
a first roller unit rotatably placed above a lower surface of the roller support, and making contact with the liquid material discharged through the discharge port; and
a second roller unit placed on a side of the first roller unit to be in contact with the first roller unit, and rotatably coupled to the roller support,
wherein the first roller unit rotates while being in contact with the second roller unit during rotation of the second roller unit, thus transferring the liquid material from the discharge port to the second roller unit.

2. The liquid-material application adapter as set forth in claim 1, wherein a concave part is provided in the upper portion of the roller support to receive the first roller unit.

3. The liquid-material application adapter as set forth in claim 2, wherein the discharge port is formed on the concave part to communicate therewith.

4. The liquid-material application adapter as set forth in claim 3, wherein a depressed portion is provided in the concave part to receive the liquid material discharged from the discharge port, and the discharge port is formed to communicate with the depressed portion.

5. The liquid-material application adapter as set forth in claim 1, wherein a plurality of grooves is formed on the first roller unit.

6. The liquid-material application adapter as set forth in claim 5, wherein the grooves are continuously formed in a direction perpendicular to a direction of rotation of the first roller unit or in the same direction as the direction of rotation thereof.

7. The liquid-material application adapter as set forth in claim 5, wherein the grooves are discontinuously formed in a direction perpendicular to a direction of rotation of the first roller unit or in the same direction as the direction of rotation thereof.

8. The liquid-material application adapter as set forth in claim 5, wherein the grooves are continuously or discontinuously formed in a direction inclined relative to a direction of rotation of the first roller unit.

9. The liquid-material application adapter as set forth in claim 8, wherein the grooves cross each other.

10. The liquid-material application adapter as set forth in claim 1, wherein a plurality of protrusions is formed on the first roller unit.

11. The liquid-material application adapter as set forth in claim 1, wherein the first roller unit comprises a plurality of balls.

12. The liquid-material application adapter as set forth in claim 1, wherein at least one of the first and second roller units comprises a plurality of rollers.

13. The liquid-material application adapter as set forth in claim 12, wherein, when the first roller unit comprises two rollers and the second roller unit comprises one roller, first and second rollers of the first roller unit are in contact with the roller of the second roller unit, and the first and second rollers of the first roller unit are spaced apart from each other.

14. The liquid-material application adapter as set forth in claim 12, wherein, when the first roller unit comprises one roller and the second roller unit comprises two rollers, the roller of the first roller unit is placed between first and second rollers of the second roller unit in such a way as to be in contact therewith, and the first and second rollers of the second roller unit are spaced apart from each other.

15. The liquid-material application adapter as set forth in claim 12, wherein, when the first roller unit comprises two rollers and the second roller unit comprises one roller, first and second rollers of the first roller unit are in contact with the roller of the second roller unit, and the first and second rollers of the first roller unit are spaced apart from each other.

16. The liquid-material application adapter as set forth in claim 12, wherein, when the first roller unit comprises two rollers and the second roller unit comprises two rollers, a first roller of the first roller unit is in contact with a first roller of the second roller unit, and a second roller of the first roller unit is in contact with a second roller of the second roller unit, the first and second rollers of the first roller unit being spaced apart from each other, and the first and second rollers of the second roller unit being spaced apart from each other.

17. The liquid-material application adapter as set forth in claim 12, wherein, when the first roller unit comprises three rollers and the second roller unit comprises one roller, a first roller of the first roller unit has on opposite sides thereof second and third rollers which are spaced apart from the roller of the second roller unit and are in contact with the first roller.

18. The liquid-material application adapter as set forth in claim 12, wherein, when the first roller unit comprises three rollers and the second roller unit comprises one roller, a first roller of the first roller unit has on opposite sides thereof second and third rollers which are in contact with the first roller, and the roller of the second roller unit is in contact with the second and third rollers of the first roller unit, and the first roller of the first roller unit and the roller of the second roller unit are spaced apart from each other.

19. The liquid-material application adapter as set forth in claim 12, wherein, when the first roller unit comprises three rollers and the second roller unit comprises two rollers, a first roller of the first roller unit has on opposite sides thereof second and third rollers which are spaced apart from each other, and first and second rollers of the second roller unit are placed, respectively, between the first and second rollers of the first roller unit and between the first and third rollers of the first roller unit, and the first and second rollers of the second roller unit are spaced apart from each other and rotate the first roller unit when the second roller unit rotates.

20. A liquid-material application adapter with a dual roller structure, comprising:
a first roller support having on an upper portion thereof a discharge port for discharging liquid material;
a first roller unit rotatably placed on the upper portion of the first roller support, and making contact with the liquid material discharged from the discharge port;
a second roller support placed on the first roller support, and having a slit through which a surface of the first roller unit is exposed; and
a second roller unit rotatably coupled to the second roller support to be in contact with the first roller unit which is exposed through the slit,
wherein, when the second roller unit rotates, the first roller unit rotates while being in contact with the second roller unit, thus transferring the liquid material from the discharge port to the second roller unit.

21. A liquid-material application apparatus, comprising:
a liquid-material application adapter described in claim 1; and
a container having an outlet that communicates with a discharge port of the liquid-material application adapter, and coupled with the liquid-material application adapter, with a pump being provided in the outlet of the container.

22. The liquid-material application apparatus as set forth in claim 21, wherein the pump comprises on a side thereof a pressurizing part, the pressurizing part being in contact with the liquid-material application adapter to be pressurized when the liquid-material application adapter moves up and down.

23. The liquid-material application apparatus as set forth in claim 22, wherein an inclined part is provided at a predetermined position on an outer surface of the liquid-material application adapter to pressurize the liquid-material application adapter.

24. A liquid-material application apparatus, comprising:
a liquid-material application adapter described in claim 20; and
a container having an outlet that communicates with a discharge port of the liquid-material application adapter, and coupled with the liquid-material application adapter, with a pump being provided in the outlet of the container.
